(19) United States
(12) Patent Application Publication
(10) Pub. No.: US 2011/0267321 A1
(43) Pub. Date: Nov. 3, 2011

(54) HEAD MOUNTED DISPLAY AND DRIVE METHOD THEREOF

(75) Inventor: Kazuhiro HAYAKAWA, Nagoya-shi (JP)

(73) Assignee: BROTHER KOGYO KABUSHIKI KAISHA, Nagoya-shi (JP)

(21) Appl. No.: 13/178,105

(22) Filed: Jul. 7, 2011

Related U.S. Application Data
(63) Continuation-in-part of application No. PCT/JP2010/050177, filed on Jan. 8, 2010.

(30) Foreign Application Priority Data
Jan. 16, 2009 (JP) 2009-007613

(51) Int. Cl. G06F 3/038; G09G 5/00

(52) U.S. Cl. 345/204; 345/8

(57) ABSTRACT

A head mounted display includes a display device and a pressure detecting part. The display device includes an eyeglass type frame provided with temples which are connected to a front frame in an openable/closable manner, a light source part, a drive part and a control part. The pressure detecting part detects opening/closing of the temple with respect to the front frame. The control part controls a starting of the operation of the drive part and a starting of the operation of a light source part corresponding to magnitude of pressure detected by the pressure detecting part.

### CROSS-REFERENCE TO RELATED APPLICATIONS

The present application is a Continuation-in-Part of International Application PCT/JP2010/050177 filed on Jan. 8, 2010, which claims the benefits of Japanese Patent Application No. 2009-007613 filed on Jan. 16, 2009.

### BACKGROUND OF THE DISCLOSURE

1. Field of the Disclosure

The present disclosure relates to a head mounted display which allows a user to observe a projected image in a state where a display device is mounted on an eyeglass-type frame.

2. Description of the Related Art

Conventionally, there has been known a head mounted display (hereinafter, referred to as “HMD”) with which a user can observe a video or an image while wearing the HMD on his head. With the use of the HMD, the user can enjoy a video such as a movie or an image in any place without selecting specific places. As the HMD, there has been known a goggle-type HMD which a user uses while wearing the HMD around his head using a band or the like and an eyeglass-type HMD in which a display device is mounted on an eyeglass-type frame. The eyeglass-type HMD in which the display device is mounted on the eyeglass-type frame is lighter than the goggle-type HMD in weight and hence, the eyeglass-type HMD can reduce a burden which the HMD imparts to the user in use. Further, the eyeglass-type HMD allows the user to easily wear or remove the HMD on or from his head.

In this manner, the user can easily wear or remove the eyeglass-type HMD in which the display device is mounted on the eyeglass-type frame. Accordingly, when a user of the eyeglass-type HMD removes the eyeglass-type HMD from his head, there is a case where the user forgets to turn off a power source of the HMD. In this case, electricity is wastefully consumed. There is also a case where when the user puts the HMD in his bag or the like, an erroneous operation that a power source switch of the HMD is erroneously turned on may occur.

An eyeglass-type HMD which is provided with a mechanism which prevents such an erroneous operation has been known. As an example, in an eyeglass-type HMD, an opening/closing detection sensor which detects opening/closing of a side frame portion is mounted on left and right hinges which connect a frame portion and the side frame portions. Also in this eyeglass-type HMD, a plurality of sensors which detect a contact with a nose or a temporal part at the time of wearing are mounted on a nose wearing portion of the frame portion and left and right side frame portions. In this eyeglass-type HMD, when the side frame portion is opened, the opening/closing detection sensor responds to such opening, and the plurality of other sensors start operations thereof using the response of the opening/closing detection sensor as a trigger. Further, in the eyeglass-type HMD, when a predetermined number or more of sensors among the plurality of other sensors respond, a display screen is turned on and a video and a menu screen are displayed. In this manner, the eyeglass-type HMD can prevent an erroneous operation. However, such an eyeglass-type HMD includes the opening/closing detection sensor and the plurality of other sensors and hence, the constitution becomes more complicated. Accordingly, there has been a demand for an HMD which can surely prevent an erroneous operation with the simple constitution.

### SUMMARY

According to one aspect of the disclosure of the present disclosure, there is provided an HMD which includes: an eyeglass-type frame including a front frame and temples which are connected to the front frame in an open/close manner; a display device which includes a light source part, a drive part which is configured to convert light emitted from the light source part into a projection light for representing an image, and a control part which is configured to control starting of an operation of the light source part and starting of an operation of the drive part; and a pressure detecting part which is configured to detect opening/closing of at least one of the temples with respect to the front frame. A wraparound endpiece is arranged at a connecting portion where the front frame and the temple are connected to each other, and an open/close part whose gap is narrowed when the temple is opened with respect to the front frame is formed on the wraparound endpiece. The pressure detecting part detects a pressure generated in the open/close part. The control part controls the starting of the operation of the drive part and the starting of the operation of the light source part corresponding to magnitude of pressure which the pressure detecting part detects.

According to another aspect of the present disclosure, there is provided a method of driving an HMD which includes: an eyeglass-type frame including a front frame and temples which are connected to the front frame in an open/close manner; and a display device which includes a light source part, a drive part which is configured to convert light emitted from the light source part into a projection light for representing an image. The HMD further includes a′pressure detecting part which is configured to detect opening/closing of at least one of the temples with respect to the front frame. The pressure detecting part detects a pressure generated by the opening/closing of the temple. The drive part starts an operation in response to detection of a first pressure by the pressure detecting part, and the light source part starts an operation in response to detection of a second pressure larger than the first pressure by the pressure detecting part.

### ADVANTAGE OF THE DISCLOSURE

According to the present disclosure, the drive part and the light source part starts an operation in response to a pressure detected by the pressure detecting part and hence, it may be possible to surely prevent the erroneous operation of the HMD with the simple constitution.

### BRIEF DESCRIPTION OF THE DRAWINGS

For a more complete understanding of the disclosure, the needs satisfied thereby, and the objects, features and advantages thereof, reference now is made to the following description taken in connection with the accompanying drawings.

FIG. 1A is a schematic perspective view of an HMD;

FIG. 1B is a schematic perspective view of the HMD;

FIG. 1C is a schematic perspective view of the HMD;

FIG. 1D is a schematic perspective view of the HMD;

FIG. 2 is a block diagram showing the basic constitution of the HMD;

FIG. 3A is a schematic view of the HMD in a state before a display part body is mounted on an eyeglass-type frame;

FIG. 3B is a schematic view of the HMD in a state where temples are not opened with the display part body mounted on the eyeglass-type frame;

FIG. 4A is a schematic view of the HMD in a state where temples are opened with the display part body mounted on the eyeglass-type frame;

FIG. 4B is a schematic view of the HMD in a state where the display part body is mounted on a head of a user;

FIG. 5A is a schematic perspective view of the display part body as viewed from an oblique upper position on a user side in a state where the display part body is mounted on the user;

FIG. 5B is a perspective view of the mounting part as viewed from a surface side of the mounting part which is brought into contact with the display part body in a state where the mounting part is mounted on the display part body;

FIG. 5C is a perspective view of the mounting part as viewed from a side opposite to a side shown in FIG. 5B;

FIG. 6 is an operational flowchart for starting a display operation of the HMD;

FIG. 7 is an operational flowchart for finishing the display operation of the HMD; and

FIG. 8 is a functional block diagram of other HMD.

### DESCRIPTION

Hereinafter, the present disclosure is explained in detail in conjunction with drawings.

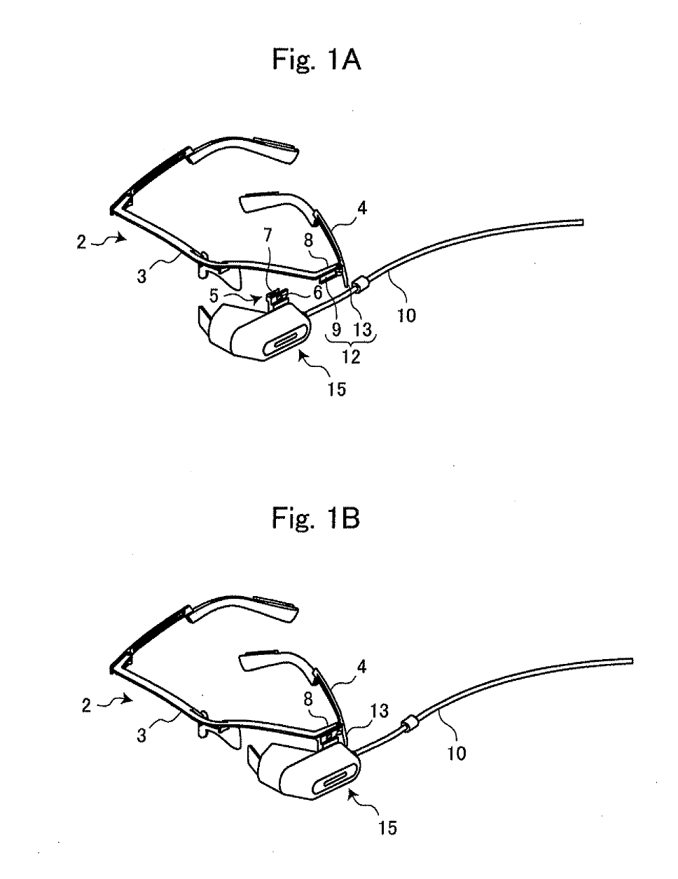

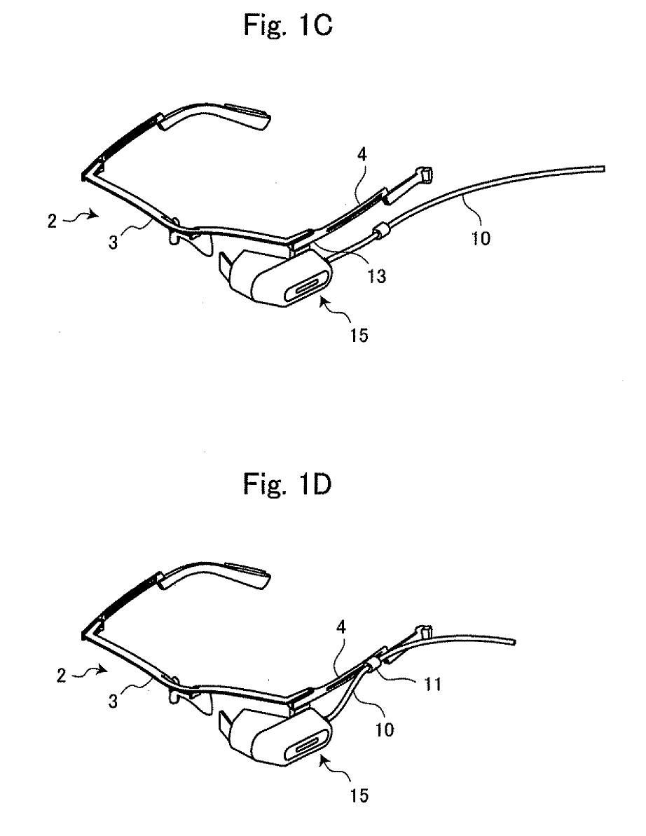

An HMD 1 which is in a state where a display part body 15 and an eyeglass-type frame 2 which constitute the HMD 1 are separated from each other is explained in conjunction with FIG. 1A. As shown in FIG. 1A, the display part body 15 projects a projection light for representing (forming) an image based on an image signal inputted through a connection line 10. The display part body 15 projects the projection light obtained by conversion on a retina of a user not shown in the drawing. The user can see a projection image by visually recognizing the projection light.

The eyeglass-type frame 2 includes a front frame 3 and wraparound endpieces 8 which are bent toward head sides of the user from the front frame 3. On a lower end of the wraparound endpiece 8, an extending part 9 which extends downward from the wraparound endpiece 8 is formed. On a distal end of the wraparound endpiece 8 on a user side, a temple 4 for fixing the HMD 1 to a temporal part of the user is rotatably connected. The temple 4 includes a pressing part 13 which extends in the direction opposite to the user side from the connection part. The pressing part 13 of the temple 4 and the extending part 9 of the wraparound endpiece 8 constitute an open/close part 12.

A mounting part 5 is arranged on the display part body 15, and a mounting jig 7 which can be mounted on the extending part 9 of the wraparound endpiece 8 is formed on an upper end portion of the mounting part 5. A pressure detecting part 6, which may be a pressure sensor, is mounted on an outer surface of the mounting jig 7.

The HMD1 which is in a state where the display part body 15 is mounted on the eyeglass-type frame 2 is explained in conjunction with FIG. 1B. The display part body 15 can be mounted on the eyeglass-type frame 2 by mounting the mounting jig 7 of the display part body 15 on the extending part 9 of the wraparound endpiece 8. Since the temple 4 is in a state where the temple 4 is closed with respect to the front frame 3, the pressing part 13 is not brought into contact with the pressure detecting part 6.

A state where the temple 4 is opened with respect to the front frame 3 is explained in conjunction with FIG. 1C. When the temple 4 is opened, the pressing part 13 is brought into contact with a front surface of the pressure detecting part 6 so that the pressure detecting part 6 detects a first pressure. Although described in detail later, in response to the detection of the first pressure by the pressure detecting part 6, a control part starts an operation of a drive part.

The HMD 1 which is in a state where the connection line 10 is fixed to the temple 4 by a holding member 11 is explained in conjunction with FIG. 1D. The display part body 15 and the eyeglass-type frame 2 are mounted on a head of the user. When the display part body 15 and the eyeglass-type frame 2 are mounted on the head of the user, the temple 4 opens more outwardly with respect to the front frame 3 and hence, the pressing part 13 presses the pressure detecting part 6 more strongly. Accordingly, the pressure detecting part 6 detects a second pressure which is larger than the first pressure and, in response to detection of the second pressure, the control part starts an operation of the light source part. In this manner, the pressure detecting part 6 is arranged in a gap between the extending part 9 and the pressing part 13 and hence, the constitution of the pressure detecting part 6 becomes simple whereby the volume and the weight of the whole HMD 1 can be reduced. Accordingly, a burden imposed on a user when he wears the HMD 1 can be reduced. Further, although the pressure detecting part 6 is not mounted on the eyeglass-type frame 2, the pressure detecting part 6 can detect the opening/closing of the eyeglass-type frame 2. Accordingly, it is unnecessary to connect the eyeglass-type frame 2 and the display part body 15 by wiring or the like. As a result, the eyeglass-type frame and the display device body can be easily separated from each other thus realizing the compact storing of these parts. Further, since the pressure detecting part 6 is mounted on the mounting jig 7, a mounting pressure can be detected by making use of an open/close mechanism of the temple 4. As a result, the pressure detecting part 6 does not come into contact with a human body and hence, the pressure detecting part 6 can surely detect whether the HMD 1 is mounted without being influenced by the posture of the human body.

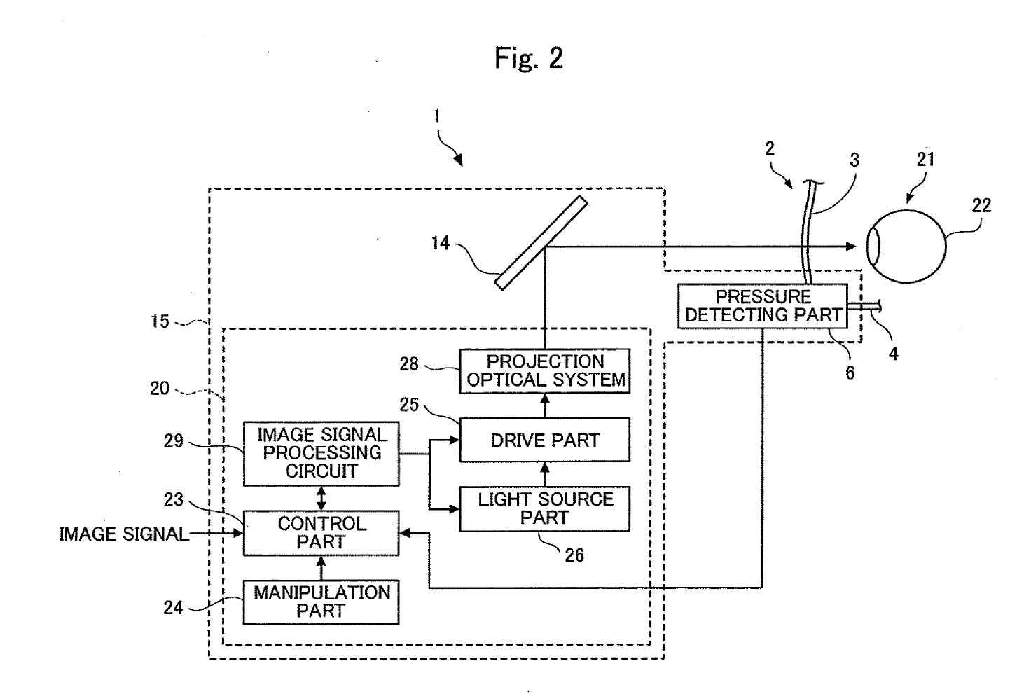

Next, the basic constitution of the HMD 1 is explained in conjunction with FIG. 2. The HMD 1 is constituted of the display part body 15 and the eyeglass-type frame 2 which holds the display part body 15. The display part body 15 is constituted of the pressure detecting part 6, a half mirror 14 and a display drive part 20. The half mirror 14 reflects a projection light irradiated from the display drive part 20 to an eyeball 21 of the user. The pressure detecting part 6 is mounted on the open/close part 12 of the eyeglass-type frame 2.

The pressure detecting part 6 is mounted on the open/close part 12. The open/close part 12 has a gap. The gap becomes narrow when the temple is opened with respect to the front frame 3. The pressure detecting part 6 may be formed of a diaphragm pressure gauge, a piezoelectric sensor including a piezoelectric element made of a lead zirconate titanate (PZT)-based, TiBa-based ceramic or the like a semiconductor pressure sensor, a strain gauge or the like.

The display drive part 20 is constituted of a control part 23, a drive part 25, a light source part 26, a projection optical system 28, an image signal processing circuit 29, and a manipulation part 24. The control part 23 controls the whole display part body 15. The light source part 26 constitutes a light source for forming a projection image. The light source part 26 may be formed of, for example, an LED (Light Emitting Diode), a cold cathode ray tube or the like. The drive part 25 converts a light irradiated from the light source part 26 into a projection light for displaying an image. The drive part 25 may be constituted of, for example, a space light modulation element such as a liquid crystal element or a DMD (Digital Mirror Device) and a drive circuit which drives the space light modulation element. The projection optical system 28 focuses the projection light on a retina 22 of the eyeball 21 of the user thus forming an image on the retina 22. The image signal processing circuit 29 generates a drive signal and a control signal which drive the drive part 25 and the light source part 26 respectively based on inputted image signals. The manipulation part 24 functions as an input means with which a user performs an inputting operation. The control part 23 performs a control of the display part body 15, and also performs a start control of the light source part 26 and a start control of the drive part 25 based on a pressure detected by the pressure detecting part 6.

The control part 23 receives an image signal inputted from the outside. The image signal processing circuit 29 obtains an image signal or image data outputted from the control part 23 and generates a drive signal or a control signal which drives or controls the drive part 25 or the light source part 26. The light source part 26 emits light based on the drive signal or the control signal. The drive part 25 converts light emitted from the light source part 26 into a projection light for displaying an image based on the drive signal. The projection optical system 28 irradiates the projection light incident on the projection optical system 28 as a projection light to form an image on the retina 22 of the user. The control part 23 generates a drive part start signal for starting an operation of the drive part 25 in response to the detection of a first pressure by the pressure detecting part 6. Further, the control part 23 generates a light source part start signal for starting an operation of the light source part 26 in response to the detection of a second pressure by the pressure detecting part 6. The image signal processing circuit 29 generates a start signal based on the drive part start signal inputted from the control part 23, transmits the start signal to the drive part 25 and starts an operation of the drive part 25. The image signal processing circuit 29 generates a start signal based on the light source part start signal inputted from the control part 23, transmits the start signal to the light source part 26 and starts an operation of the light source part 26.

The display part body 15 may be a retinal scanning display. In this case, the drive part 25 may be constituted of an optical scanner which scans light beams inputted from the light source part 26 by reflecting the light beams on a oscillating reflection surface. The light source part 26, in this case, emits light beams whose emission intensities are modulated based on brightness signals of respective colors which are inputted from the image signal processing circuit 29. The display part body 15 may be a liquid crystal display device. In this case, the drive part 25 may be constituted of a light-transmission-type liquid crystal panel, and the light source part 26 is an illumination light source which irradiates light to the liquid crystal panel. In this case, image data which constitutes a drive signal is inputted to the drive part 25 from the image signal processing circuit 29, and the drive part 25 controls a transmission light quantity of light irradiated from the light source part 26 for every pixel based on the image data.

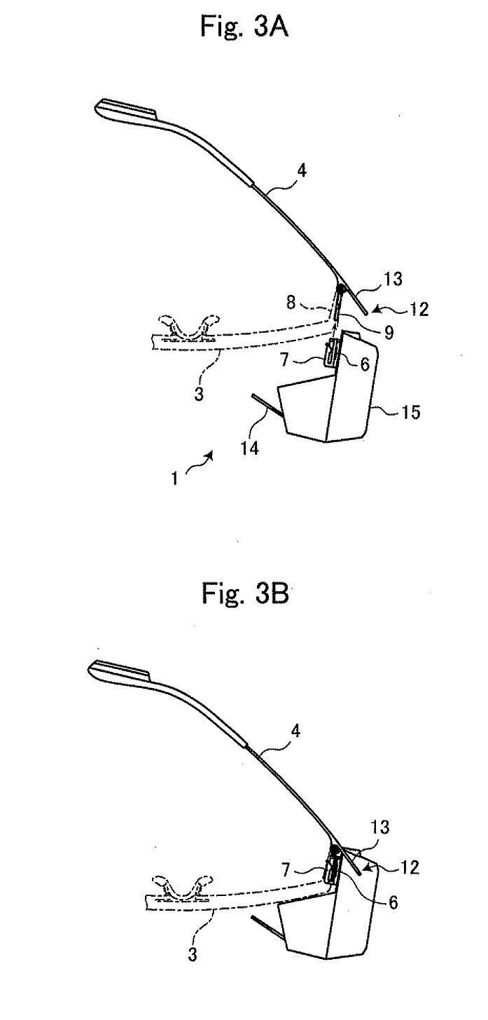

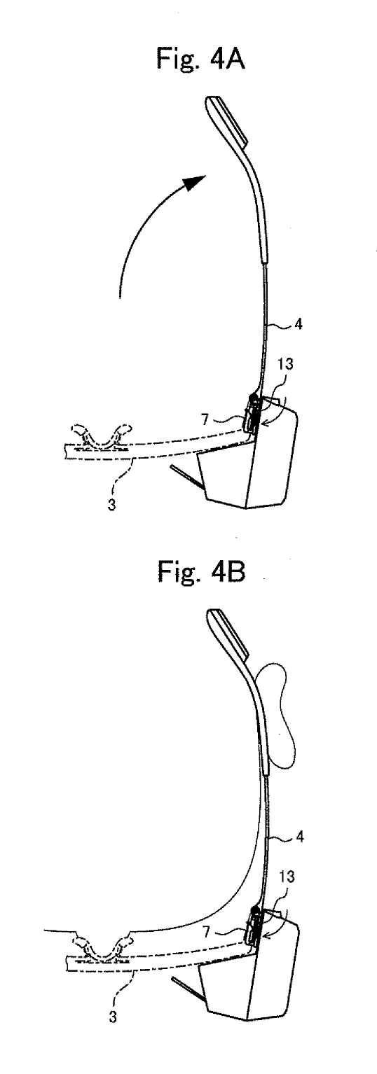

The manner of operation where HMD1 of the embodiment according to the present disclosure is mounted on a head portion of a user after the display part body 15 is mounted on the eyeglass-type frame 2 is specifically explained in conjunction with FIG. 3A, FIG. 3B, FIG. 4A and FIG. 4B. These drawings show the display part body 15 which is mounted on the eyeglass-type frame 2 as viewed from above.

As shown in FIG. 3A, the eyeglass-type frame 2 is constituted of the front frame 3, the wraparound endpieces 8 which are bent toward a user side of the front frame 3, the extending parts 9 which extend downward from the wraparound endpieces 8, and the temples 4 which are rotatably connected to distal end portions of the wraparound endpieces 8 on the user side. The temple 4 includes the pressing part 13 which projects more outside than a connection portion which connects the temple 4 with the wraparound endpiece 8. The open/close part 12 is constituted of the extending part 9 and the pressing part 13. The display part body 15 is constituted of the half mirror 14 which is mounted on a light emitting opening from which the projection light is emitted, a mounting jig 7 which is mounted on the extending part 9 of the eyeglass-type frame 2, and the pressure detecting part 6 which is mounted on an outer surface of the mounting jig 7.

As shown in FIG. 3B, the display part body 15 is mounted on the eyeglass-type frame 2 by mounting the mounting jig 7 of the display part body 15 on the extending part 9 of the eyeglass-type frame 2. The open/close part 12 is opened in this state and hence, the pressure detecting part 6 detects no pressure. FIG. 4A shows a state where the temple 4 is opened so that the open/close part 12 is closed. Accordingly, the pressing part 13 of the temple 4 presses the pressure detecting part 6 and the pressure detecting part 6 detects a first pressure. FIG. 4B shows a state where the eyeglass-type frame 2 is mounted on the head of the user. Since the temple 4 is further opened by the head of the user, the pressing part 13 further presses the pressure detecting part 6. Accordingly, the pressure detecting part 6 detects a second pressure which is larger than the first pressure.

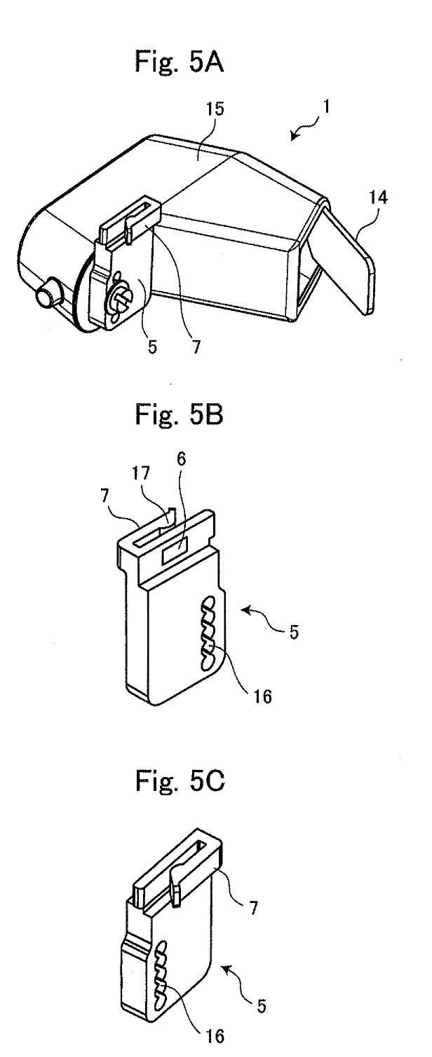

The display part body 15 of the HMD 1 of this embodiment according to the present disclosure is specifically explained in conjunction with FIG. 5A to FIG. 5C.

As shown in FIG. 5A, the half mirror 14 is mounted on the light emitting opening from which the projection light is emitted and the mounting part 5 is fixed to a side surface of the display part body 15 by a bolt. As shown in FIG. 5B and FIG. 5C, a mounting hole 16 is formed in the mounting part 5. Accordingly, the user can adjust a mounting position of the mounting part 5 in fixing the mounting part 5 to the side surface of the display part body 15 by the bolt. The mounting jig 7 having a clip-shape which is mountable on the extending part 9 of the eyeglass-type frame 2 is formed on an upper end portion of the mounting part 5. The pressure detecting part 6 is mounted on one surface of the mounting jig 7.

An L-shaped sliding portion is formed on a lower end of the extending part 9 of the wraparound endpiece 8. By mounting the mounting jig 7 on the sliding portion, the display part body 15 is mounted on the eyeglass-type frame 2. A projecting part 17 is formed on an inner side of the clip portion of the mounting jig 7. A recessed part not shown in the drawing which is engageable with the projecting part 17 is formed on the extending part 9. Accordingly, when the mounting jig 7 is mounted on the extending part 9, the projecting part 17 and the recessed part are engaged with each other. Accordingly, the display part body 15 is prevented from being removed from the eyeglass-type frame 2 and from falling.

The mounting structure for mounting the display part body 15 on the eyeglass-type frame 2 which has been explained heretofore is an example. That is, although the mounting jig 7 of the display part body 15 is mounted on the extending part 9 of the wraparound endpiece 8 from a front side toward a back side of the user in the HMD 1 of the above-mentioned embodiment, the mounting direction is not limited to such a direction. For example, the mounting jig 7 may be mounted on the extending part 9 of the wraparound endpiece 8 from the back side toward the front side of the user, or the mounting jig 7 may be mounted from the lower side toward the upper side of the user. Further, the mounting structure may have the structure where the mounting jig 7 is formed in a clip shape on an upper end of the mounting part 5 such that the clip shape extends in the longitudinal direction, and the mounting jig 7 is mounted on the extending part 9 from the upper side toward the lower side in such a manner that the clip-shaped part of the mounting jig 7 sandwiches the wraparound endpiece 8. The display part body 15 may be mounted on a part of the eyeglass-type frame 2 other than the wraparound endpiece 8. However, in all these mounting structures, the pressure detecting part 6 is arranged to be sandwiched in a gap defined between the extending part 9 and the pressing part 13 which constitute the open/close part 12.

In the above-mentioned embodiment, the open/close part 12 is constituted of the extending part 9 which is formed below the wraparound endpiece 8 and the pressing part 13 which extends from the temple 4. However, the structure of the open/close part 12 is not limited to such structure. For example, the open/close part 12 may adopt the structure where the rotation of the temple 4 is stopped by bringing a distal end portion of the wraparound endpiece 8 and a distal end portion of the temple 4 into contact with each other and the open/close part 12 is constituted of the distal end portion of the wraparound endpiece 8 and the distal end portion of the temple 4. In this case, when the display part body 15 is mounted on the eyeglass-type frame 2, the pressure detecting part 6 is sandwiched between the display part body 15 and the eyeglass-type frame 2. Due to such structure, it is possible to provide the HMD in a compact shape by eliminating a projecting portion from the open/close part 12 thus providing the HMD with the hardly broken structure.

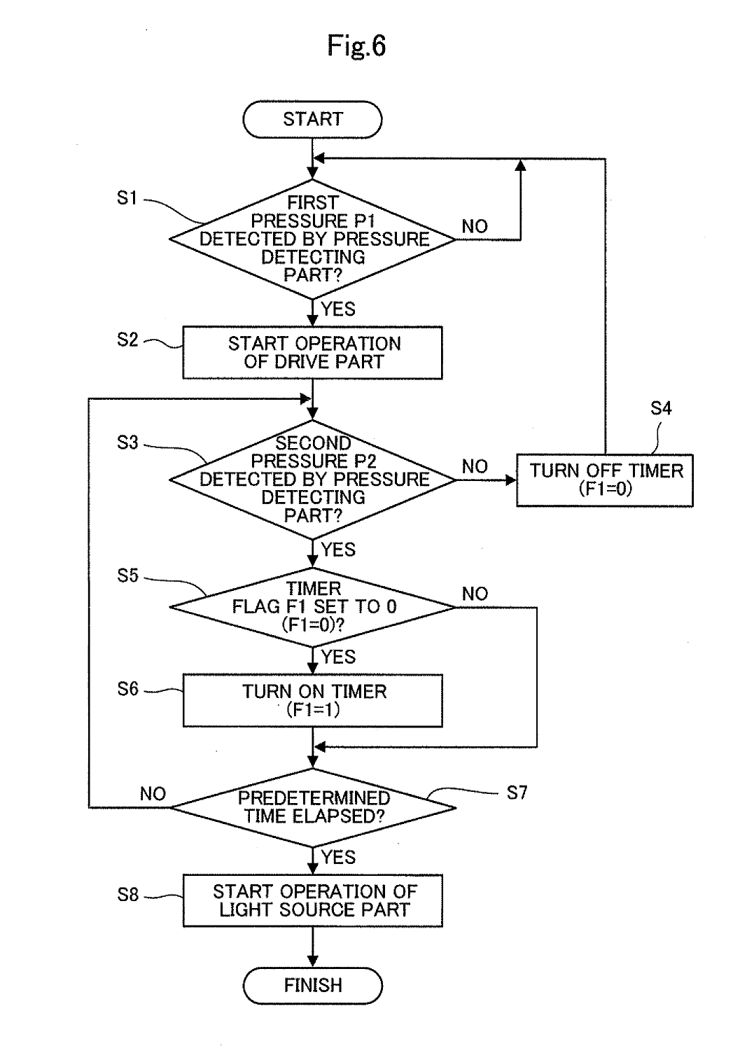

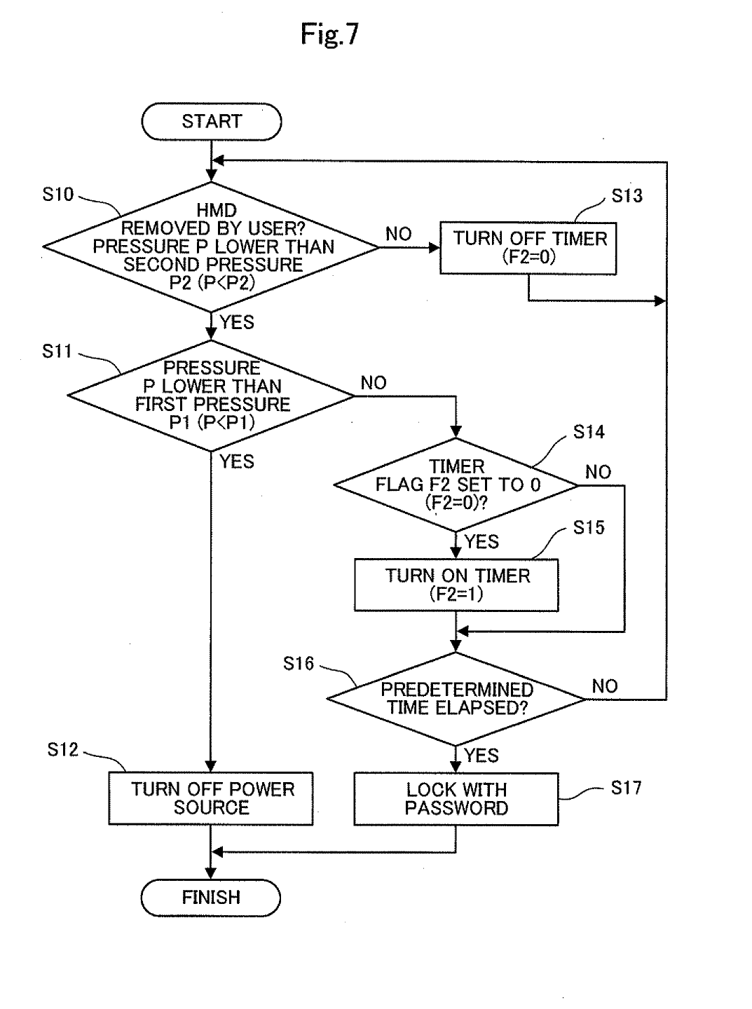

Next, the method of driving the HMD 1 according to the embodiment of the present disclosure is specifically explained in conjunction with FIG. 6 and FIG. 7.

The manner of starting the operation of the HMD 1 is explained in conjunction with FIG. 6. When a user mounts the display part body 15 on the eyeglass-type frame 2 and electricity is supplied to the HMD 1, the operation of the HMD 1 is started. By supplying electricity to the HMD 1, the operation of the control part 23 is started. Here, the electricity is supplied when the user manipulates the manipulation part 24. When the temple 4 is in a closed state with respect to the front frame 3, the pressure detecting part 6 does not detect a first pressure P1 and is in a standby state (step S1: No). On the other hand, when the temple 4 is opened with respect to the front frame 3 and the pressing part 13 is brought into contact with the pressure detecting part 6, the pressure detecting part 6 detects a first pressure P1 (step S1: Yes). When the pressure detecting part 6 detects the first pressure P1, the control part 23 generates a drive part start signal, and controls the image signal processing circuit 29 such that the image signal processing circuit 29 starts the operation of the drive part 25 (step S2).

When the pressure detecting part 6 does not detect a second pressure P2 (step S3: No), the control part 23 turns off a timer by setting a timer flag F1 to 0 (F1=0) (step S4), and maintains the standby state in step S1. When the timer is already turned off, an OFF state is maintained. Accordingly, in the OFF state, although the operation of the drive part 25 is already started, the operation of the light source part 26 is not started. When the pressure detecting part 6 detects the second pressure P2 (step S3: Yes), the control part 23 determines whether or not the timer flag F1 is set to 0 (F1=0) (step S5). When the control part 23 determines that the timer flag F1 is set to 0 (F1=0) (step S5: Yes), the control part 23 turns on the timer by setting the timer flag F1 to 1 (F1=1) (step S6). Thereafter, the control part 23 monitors the timer and, when the control part 23 detects that a predetermined time elapses (step S7: Yes), the control part 23 allows the light source part 26 to start the operation for emitting light (step S8). When the control part 23 determines that the timer flag F1 is not set to 0, that is, the timer flag F1 is set to 1 (F1=1) in step S5 (step S5: No), the processing advances to step S7 where the control part 23 determines whether or not a predetermined time elapses.

In this manner, firstly, when the temple 4 is opened, the pressure detecting part 6 detects the first pressure P1, and the operation of the drive part 25 is started. Further, when the HMD 1 is mounted on a head of a user and the pressure detecting part 6 detects the second pressure P2, the operation of the light source part 26 is started. Accordingly, a mounting state of the HMD 1 on the user can be surely detected and hence, it is possible to surely prevent an erroneous operation. Further, the power consumption of the HMD 1 when a user does not wear the HMD 1 can be decreased. Still further, the operation of the light source part 26 is started so as to emit light after at least a predetermined time elapses from a point of time that the driving of the drive part 25 is started. Accordingly, even when a temple is temporarily opened with a strong force, it is not determined that the HMD 1 is mounted on the user and hence, an erroneous operation can be prevented. Further, a wasteful driving of the light source part can be prevented and hence, the HMD 1 can reduce the power consumption. Still further, the HMD 1 projects a projection light after the operation of the drive part 25 is stabilized. Accordingly, the user can see a stable display image from a point of time immediately after the projection light is projected.

In the above-mentioned embodiment, the drive part 25 is driven immediately after the pressure detecting part 6 detects the first pressure P1 (step S2). However, the operation of the drive part 25 may be started after a predetermined time elapses from the detection of the first pressure P1. By starting the operation of the drive part 25 after the predetermined time elapses from the detection of the first pressure P1, it is possible to prevent a situation where the operation of the drive part 25 is started every time the temple 4 is erroneously opened and hence, the wasteful power consumption can be prevented.

The finishing of the operation is explained in conjunction with FIG. 7. The control part 23 determines whether or not a pressure P detected by the pressure detecting part 6 is smaller than the second pressure P2 (step S10). When the control part 23 determines that the HMD 1 is removed from the head of the user and the pressure P detected by the pressure detecting part 6 becomes lower than the second pressure P2 (step SW: Yes), the control part 23 further determines whether or not the pressure P detected by the pressure detecting part 6 is lower than the first pressure P1 (step S11). When the control part 23 determines that the pressure P is 0, for example (step S11: Yes), the power source of the HMD 1 including the drive part 25 and the light source part 26 is turned off (step S12), and the operation of the HMD 1 is finished. On the other hand, when the control part 23 determines that the pressure P detected by the pressure detecting part 6 is higher than the second pressure P2 (step S10: No), the control part 23 turns off the timer by setting the timer flag F2 to 0 (F2=0) (step S13), and the processing returns to step S10.

When the control part 23 determines that the pressure P detected by the pressure detecting part 6 is higher than the first pressure P1 in step S11 (step S11: No), the control part 23 determines whether or not the timer flag F2 is set to 0 (F2=0), that is, whether or not the timer is turned off (step S14). When the control part 23 determines that the timer flag F2 is set to 0 (F2=0) and the timer is turned off (step S14: Yes), the control part 23 turns on the timer by setting the timer flag F2 to 1 (F2=1) (step S15).

When the processing in step S15 is finished or when the control part 23 determines that the timer flag F2 is not set to 0, that is, the timer flag F2 is set to 1 (F2=1) so that the timer flag is raised (step S14: No), the control part 23 executes the processing in step S16. In step S16, the control part 23 determines whether or not the timer detects a lapse of a predetermined time. In this processing, when the control part 23 determines that the predetermined time elapses (step S16: Yes), the control part 23 locks this state such that the state cannot be released without inputting a password (step S17), and the processing is finished. This state is locked such that the operation of the drive part 25 and the operation of the light source part 26 are continued so that the projection light is projected. Even when the temple 4 is closed in such a state, the projection operation of the HMD 1 is continued. By inputting a password from the manipulation part 24, the user can perform a usual operation.

When the control part 23 determines that the predetermined time does not elapse (step S16: No), the processing returns to step S10. When the temple 4 is closed during a predetermined period where the timer flag F2 is set to 1 (F2=1), that is, the timer is in an operation state with this state, the pressure P detected by the pressure detecting part 6 becomes lower than P1 (P<P1) (step S11: Yes) and hence, the control part 23 turns off the power source of the HMD 1 for stopping the operation of the HMD 1. When a state where the temple 4 is opened (detected pressure P≧P1) is maintained for a predetermined time, the HMD 1 is locked in a state where the projection operation is maintained. This is because there may be a case where, immediately after removing the HMD 1, the user temporarily puts the HMD 1 on a desk without folding the temple so as to see the continuation of a display image by mounting the HMD 1 on his head. Here, the HMD 1 is locked with a password and hence, even when another person mounts the HMD 1 on his head in such a state, he cannot see the display image unless the password is inputted. Accordingly, display contents are not leaked to the person and hence, the security of the display contents is ensured. There may be also a case where even when a user removes the HMD 1 from his head, the user immediately mounts the HMD 1 on his head so as to see a projected image. There may be further a case where a user removes the HMD 1 from his head and mounts the HMD 1 again on his head after a while. In these cases, it is inconvenient to turn off the power source of the HMD 1 each time the user removes the HMD 1 from his head.

In step S12 where the power source is turned off, the operation of the HMD 1 is stopped in stages such that the driving of the light source part 26 is firstly stopped and, thereafter, the power source of the drive part 25 is turned off. By stopping the driving of the light source part 26 firstly, it is possible to prevent a situation where the drive part 25 is stopped firstly so that an unstable projection light is projected. Further, when an optical scanner is used as a drive part of the HMD 1, by stopping the light source part 26 firstly, it is possible to prevent the leakage of a strong light to the outside.

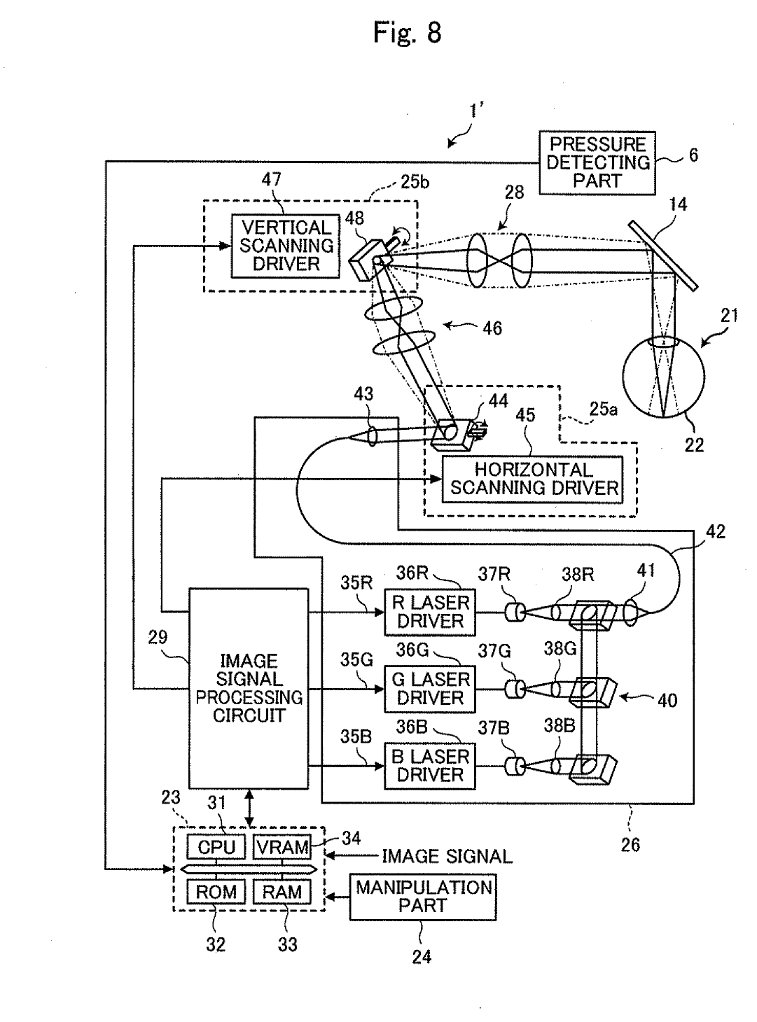

Next, an HMD 1′ of another embodiment according to the present disclosure is explained in conjunction with FIG. 8. Another embodiment relates to an example where a retinal scanning display is used as an HMD. In FIG. 8, an eyeglass-type frame 2 is omitted.

The HMD 1′ includes a control part 23, an image signal processing circuit 29, a light source part 26, a drive part 25a, a relay optical system 46, a drive part 25b, a projection optical system 28, a half mirror 14, and a pressure detecting part 6. The control part 23 performs a control of whole HMD 1′ and operation start controls of the light source part 26, and the drive parts 25a, 25b. The image signal processing circuit 29 generates a drive signal and a brightness signal by processing an input image signal and also performs start controls of the drive parts 25a, 25b and the light source part 26. The light source part 26 irradiates light beams which are modulated based on the image signal. The drive part 25a scans the light beams irradiated from the light source part 26 in the horizontal direction. The relay optical system 46 transmits the scanned beams scanned in the horizontal direction. The drive part 25b scans the scanning beams transmitted from the relay optical system 46 in the vertical direction. The projection optical system 28 projects the scanned beams scanned two-dimensionally. The half mirror 14 reflects the projected scanned beams to an eyeball 21. The pressure detecting part 6 is mounted on an open/close part formed on a wraparound endpiece of an eyeglass-type frame not shown in the drawing.

Also in the HMD1′ of this embodiment, in the same manner as explained heretofore, in response to the detection of a first pressure by a pressure detecting part 6, the control part 23 starts the operations of the drive parts 25a, 25b via the image signal processing circuit 29. Further, in response to the detection of a second pressure by the pressure detecting part 6, the control part 23 starts the operation of the light source part 26 via the image signal processing circuit 29.

Hereinafter, respective constitutional parts are specifically explained. The control part 23 is constituted of a CPU 31, a ROM 32, a RAM 33 and a VRAM 34. The CPU 31 executes a program. The ROM 32 stores a main program which controls the operation of the HMD 1′, a pressure determination program which determines a pressure detected by the pressure detecting part 6 and the like. When the CPU 31 reads a program from the ROM 32 and executes the program, the RAM 33 is used as a working area of the program. The VRAM 34 stores an image data based on an image signal inputted from the outside. The control part 23 performs the processing of the inputted image signal, the determination of a pressure detected by the pressure detecting part 6, and a control of an input signal from a manipulation part 24 and the like.

The manipulation part 24 has an input function for inputting information to the HMD 1′. For example, the manipulation part 24 functions as an input unit which turns on a power source of the HMD 1′. Further, the manipulation part 24 functions as an input unit for inputting a password when a locked state is released. Besides these functions, the manipulation part 24 also functions as an input unit for setting projection conditions and the like.

The image signal processing circuit 29 generates various signals for generating a two-dimensional image by processing an image signal inputted from the outside and image data inputted from the VRAM 34. The image signal processing circuit 29 synchronizes a brightness signal given to the light source part 26 and a drive signal for driving the drive part 25, and supplies a horizontal drive signal for scanning light beams in the horizontal direction to the drive part 25a and a vertical drive signal for scanning light beams in the vertical direction to the drive part 25b respectively. Further, the image signal processing circuit 29 supplies a red brightness signal 35R, a green brightness signal 35G, and a blue brightness signal 35B to an R laser driver 36R, a G laser driver 36G, and a B laser driver 36B respectively time-sequentially. Further, the image signal processing circuit 29 performs operation start controls of the drive parts 25a, 25b and the light source part 26 based on the control by the control part 23.

The light source part 26 includes laser diodes 37R, 37G, 37B for emitting laser beams and laser drivers 36R, 36G, 36B for driving the respective laser diodes 37R, 37G, 37B. Further, the light source part 26 includes a collimation optical systems 38R, 38G, 38B which respectively collimate a red light beam, a green light beam and a blue light beam which are emitted from the respective laser diodes 37R, 37G, 37B, and dichroic mirrors 40 which synthesize light beams of respective colors. Further, the light source part 26 includes an image forming optical system 41 for introducing a synthesized light from the dichroic mirrors 40 to an optical fiber 42, and a collimation optical system 43 which collimates light beams radiated from the optical fiber 42.

The drive part 25a is constituted of a horizontal scanning optical scanner 44 which scans a collimated light in the horizontal direction and a horizontal scanning driver 45 for driving the horizontal scanning optical scanner 44. The horizontal scanning driver 45 oscillates a reflection part of the horizontal scanning optical scanner 44 in the direction indicated by an arrow based on a horizontal drive signal inputted from the image signal processing circuit 29. The relay optical system 46 guides the scanned light beams radiated from the drive part 25a to the drive part 25b. The drive part 25b includes a vertical scanning optical scanner 48 which scans the incident scanned light beams in the vertical direction and a vertical scanning driver 47 which drives the vertical scanning optical scanner 48. The vertical scanning driver 47 oscillates a reflection part of the vertical scanning optical scanner 48 based on a vertical drive signal inputted from the image signal processing circuit 29. The projection optical system 28 irradiates the scanned light beams which are scanned horizontally and vertically to the half mirror 14. A projection image is formed on a retina 22 of a user by the scanned light beams reflected on the half mirror 14.

This type of retinal scanning display has the light-weighted and compact constitution and hence, the retinal scanning display can be easily mounted on the eyeglass-type frame 2. Accordingly, a burden which a user bears in wearing, the HMD 1′ on his head can be reduced. Further, in constituting the HMD 1′, the parts can be mounted in a separable manner that the manipulation part 24, the control part 23, the image signal processing circuit 29 and the light source part 26 are mounted on the body part, and the drive parts 25a, 25b, the relay optical system 46, the projection optical system 28 and the half mirror 14 are mounted on the projection part which is mounted on the eyeglass-type frame 2. In this case, for example, by putting the body part in a pocket of a clothing of a user and by mounting the projection part on the eyeglass-type frame 2, the projection part becomes more light-weighted. Accordingly, a discomfort which the user may feel in wearing the HMD 1′ on his head can be further reduced.

What is claimed is:

1. A head mounted display comprising:
an eyeglass-type frame comprising a front frame and temples which are connected to the front frame in an open/close manner;
a display device which includes a light source part, a drive part which is configured to convert light emitted from the light source part into a projection light for representing an image, and a control part which is configured to control starting of an operation of the light source part and starting of an operation of the drive part; and
a pressure detecting part which is configured to detect opening/closing of at least one of the temples with respect to the front frame, wherein
a wraparound endpiece is arranged at a connecting portion where the front frame and the temple are connected to each other,
an open/close part whose gap is narrowed when the temple is configured to be opened with respect to the front frame is mounted on the wraparound endpiece,
the pressure detecting part is configured to detect a pressure generated in the open/close part, and
the control part is configured to control the starting of the operation of the drive part and the starting of the operation of the light source part corresponding to magnitude of pressure which the pressure detecting part detects.

2. The head mounted display according to claim 1, wherein the pressure detecting part is configured to detect a first pressure in a state where the temple is opened with respect to the front frame and to detect a second pressure larger than the first pressure in a state where the eyeglass-type frame is mounted on a head of a user, and
the control part is configured to start the operation of the light source part in response to detection of the second pressure by the pressure detecting part.

3. The head mounted display according to claim 2, wherein the control part is configured to start the operation of the drive part in response to detection of the first pressure by the pressure detecting part.

4. The head mounted display according to claim 3, wherein the drive part includes an optical scanner part which is configured to convert light emitted from the light source part into a projection light by scanning the light with a oscillating reflection surface.

5. The head mounted display according to claim 1, wherein the pressure detecting part is arranged in a gap of the open/close part.

6. The head mounted display according to claim 1, wherein the display device includes a mounting part which is detachably mounted on the eyeglass-type frame, and the pressure detecting part is mounted on the mounting part.

7. The head mounted display according to claim 6, wherein the mounting part includes a mounting jig which is inserted into a gap of the open/close part, and the pressure detecting part is mounted on the mounting jig.

8. The head mounted display according to claim 4, wherein the control part is configured to start the operation of the drive part after a predetermined time elapses from detection of the first pressure by the pressure detecting part.

9. The head mounted display according to claim 4, wherein the control part is configured to allow the light source part to emit light after a predetermined time elapses from detection of the second pressure by the pressure detecting part.

10. A method of driving a head mounted display comprising: an eyeglass-type frame comprising a front frame and temples which are connected to the front frame in an open/close manner; and a display device which includes a light source part, a drive part which is configured to convert light emitted from the light source part into a projection light for representing an image, the head mounted display further comprising a pressure detecting part which is configured to detect opening/closing of at least one of the temples with respect to the front frame, the method comprising the steps of:
detecting a pressure generated by the opening/closing of the temple by the pressure detecting part;
starting an operation of the drive part in response to detection of a first pressure by the pressure detecting part; and
starting an operation of the light source part in response to detection of a second pressure larger than the first pressure by the pressure detecting part.
